(19) United States
(12) Patent Application Publication
(10) Pub. No.: US 2014/0207657 A1
(43) Pub. Date: Jul. 24, 2014

(54) PURCHASE AND RENTAL SYSTEM AND METHOD

(71) Applicant: Kalman Gacs, Needham, MA (US)

(72) Inventor: Kalman Gacs, Needham, MA (US)

(21) Appl. No.: 13/745,838

(22) Filed: Jan. 20, 2013

(51) Int. Cl. G06Q 20/42

(52) U.S. Cl. CPC G06Q 20/42; G06Q 30/0645
USPC 705/39

(57) ABSTRACT

One embodiment of the system involves providing one or more goods that are physically present but secured against removal through some locking or restraint mechanism. If a consumer desires a locked item, the consumer effects payment via remote means, such as via use of the Internet and/or via a smartphone. Upon confirmation of payment, the system responds with a means for the consumer to remove the lock from the purchased item and to take immediate possession. In some cases, this may be via the provision of a combination or code that is then used physically by the user to unlock the merchandise.

This patent application claims priority to U.S. Provisional Patent Application Ser. No. 61/588,714 filed on Jan. 20, 2012, which is incorporated by reference herein in its entirety.

### BACKGROUND OF THE SYSTEM

Purchase and rental transactions are currently implemented in two approaches, online (digital) and live (analog). In the digital system, the goods or services to be obtained are located at a remote location (i.e. a warehouse or distribution center) but are catalogued at a web site so that a consumer can see a description, price, availability, and possibly reviews of the goods by other users. If interested, the purchaser can provide financial information to complete a purchase and await delivery of the goods to their home or for in-store pickup. This system has the disadvantage of delayed gratification on the part of the consumer by the need to wait for the delivery of the product and the inability in most cases to physically inspect or handle the goods.

In the live (also sometimes referred to as the “bricks and mortar” approach) the consumer can physically see and handle the goods at a store or other location and, with the assistance of onsite staff, can complete a purchase and typically leave the store with the goods themselves. A disadvantage of this approach is the need for staff to be available to complete consumer transactions, to prevent theft of the offered goods, and the like. This either requires constant employee presence, or, in the alternative, limited hours and availability.

### SUMMARY OF THE SYSTEM

One embodiment of the system involves providing one or more goods that are physically present but secured against removal through some locking or restraint mechanism. If a consumer desires a locked item, the consumer effects payment via remote means, such as via use of the Internet and/or via a smartphone. Upon confirmation of payment, the system responds with a means for the consumer to remove the lock from the purchased item and to take immediate possession. In some cases, this may be via the provision of a combination or code that is then used physically by the user to unlock the merchandise.

One embodiment provides a system and method for connecting users with a means to rent or purchase goods or services at any time while allowing inspection of the goods or services, allowing placement of goods in more places, and generating another means of advertisement. According to the system, at least one good or service that a user wishes to purchase or rent is identified by the user. Services could include downloading software or mobile applications, or any other suitable service that can be locked or secured prior to prevent unauthorized use. The present system is a method for selling items that are locked with a combination lock or any means of denying access such as a code. The system allows for the release of merchandise to a buyer without the need for supervision from the retailer or the need for customized equipment. The system facilitates a transaction of merchandise where the item for sale is locked with a combination lock and the combination is sent electronically, communicated by voice, or otherwise communicated to the purchaser upon payment for the item.

The system thus provides rapid access at any time to information, such as a code or the combination for a lock to a user allowing rentals or purchases to occur at any time, including when vendors are closed. Moreover, the present system allows vendors to make sales or rentals without the need for sales personnel to be present and allows users to purchase or rent goods or services after having an opportunity to inspect the goods or services at any time of the day.

These and other aspects, features, implementations, and advantages, and combinations, can be expressed as methods, apparatus, systems, components, program products, business methods, and means or steps for performing functions, or combinations of these. Other features, aspects, implementations, and advantages will become apparent from the description, the drawings, and other specifications of the system.

### BRIEF DESCRIPTION OF THE DRAWINGS

FIG. 1 is a block diagram of an embodiment of the system.

FIG. 2 is a flow diagram illustrating the operation of an embodiment of the vendor operation of the system.

FIG. 3 illustrates a helmet vending embodiment.

FIG. 4 is a flow diagram illustrating the operation of the consumer operation of an embodiment of the system.

FIG. 5 is a flow diagram illustrating the operation of a rental embodiment of the system.

FIG. 6 is an example computer environment.

### DETAILED DESCRIPTION OF THE SYSTEM

The system provides a method and apparatus for unattended sales or rental of goods and services by securing items for consumption and providing a means of unlocking the items after confirmation of payment or rental fee. The system is described below in a number of examples, including the sale or rental of bikes, helmets, and other goods. It should be understood that the system is not limited to these examples, and other goods and services may be used without departing from the scope and spirit of the system.

The present system is a method and system for selling items that are locked with, for example, a combination lock. The method allows for selling items without direct human interaction required. Payment is made online or via text message, the combination is sent back electronically to the purchaser and the unlocking of the combination lock completes the purchase. It should be noted that any combination lock can be used. The lock can be digital or analog and have letters, numerals or other figures. The lock does not have to have Internet access.

In one embodiment, the system may be used to sell or rent bikes. Many people sell used bikes with a “for sale” sign with a telephone number placed on the bike for sale. If a consumer sees the bike for sale and desires to purchase the bike, the consumer must call the seller. At the time of the call, the seller may be unavailable to meet the consumer and it can be hard to arrange a transfer of the bike.

Similarly, bike shops are not typically open 24 hours a day. However, there may be opportunities for a sale after hours, if there were a secure way to display and sell the bike.

In an embodiment of the system, each bike is locked in some manner whereby the lock itself can be unlocked via a code or combination of some type. This allows the consumer to see and touch the bike in person before making a decision (unlike an online purchase). The system contemplates the buyer paying through an automated system with a mobile phone or through a desktop computer. Upon confirmation of the payment for the bike, the consumer receives the combination for the lock that has been securing the bike. The consumer (now owner) unlocks the lock and takes possession of the bike.

In operation, each locked item and/or each lock has some indicia that allow a unique identification in a database. In one embodiment, the locks can be taken by the purchaser as part of the purchase. In other situations, the locks are such that they remain at the point-of-sale location. The consumer scans or enters the indicia into a smart phone, tablet computer, PDA, laptop, or other network accessible device, and the user is presented with information about the item to be purchased.

Vendor Operation

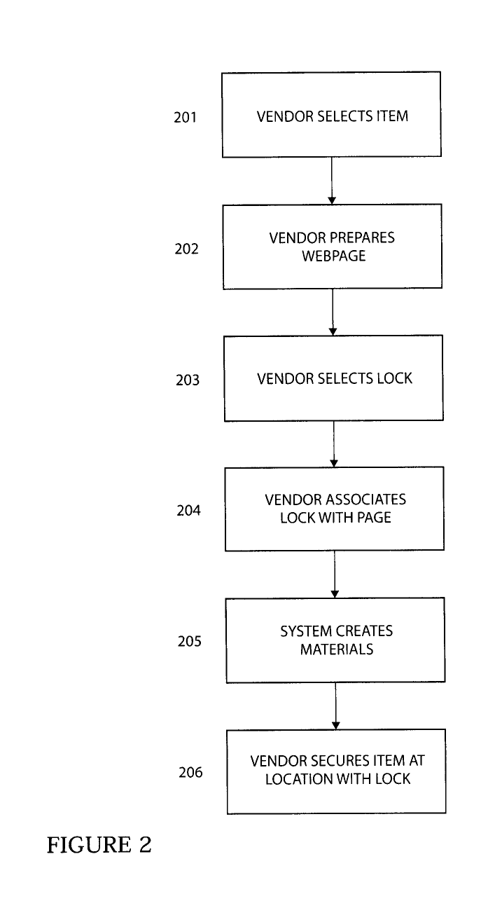

FIG. 2 is a flowchart illustrating the operation of an embodiment of the system in preparing an item for sale and display. At step 201, the vendor selects the item to be offered for sale. At step 202 the vendor prepares a web page/advertisement describing the item and including the price and instructions for buying and possessing the item. This comprises configuring the item sell page on a computing device connected over the Internet or any computer network, such as a LAN, long area network, or WAN, wide area network, to a server. All aspects of the process are customizable and a reseller can reuse settings for similar items to be sold. Example fields could include name of item, price, location, description of lock or code, description of merchandise, lock combination(s) or code(s), the deposit amount and rate for rentals, whether or not the vendor wishes the merchandise to be listed on a map of items, whether or not the vendor wishes the merchandise to be added to additional listing services, and pictures and/or audio and/or video describing the merchandise. The merchandise registration information is stored on the merchandise database together with a lock code selected from the lock database.

The system generates a web page for locked merchandise with price and “check out,” “add to cart,” “pay-to-unlock,” “pay to receive combination” or “send payment” buttons to buy item. In one embodiment, the website takes payment information from the potential customer on the initial page.

A vendor database keeps all the information entered about the item for sale. The system posts information about the item on a map and posts the information simultaneously on other sites such as a social network, as to notify potential customers that the item is for sale. In some cases, the vendor may simply let the item at its locked location represent the advertising for the item. In other cases, the vendor may wish to advertise the availability on-line, off-line, via text, tweet, IM, or any other suitable means of advertising.

At step 203 the vendor selects the lock to be used to secure the merchandise. As noted above, any combination lock or code can be used. The lock can be digital or analog and have letters, numerals or other figures. The lock does not have to have Internet access itself, but can be purely mechanical. The lock should have some indicia on it representing a serial number or other identifying information that allows the vendor to know which lock (and item) is the subject of any possible query to the vendor system.

At step 204 the vendor associates the lock with the item and the web page, typically in a relational database or in some other manner. In one embodiment, the item itself will have its own indicia to confirm identity of the item. In some cases, the indicia on the lock and the indicia on the item can be the same. In other cases, there may be two separate indicia and the consumer will be invited to enter or scan both as a double check on the item to be purchased.

In one embodiment, the system generates the indicia and produces a printable form for the vendor to print and place as advertisement on or near the merchandise and/or lock. If the lock already has a visible serial number, that may serve as the indicia in one embodiment. In other embodiments, a Quick Response (QR) code, or other bar code, is also generated to correspond to the URL of the item and to send the potential customer to the correct URL for the transaction. The generated indicia may be affixed to the item and/or lock or somehow placed on or near the item for sale.

At step 204 the lock, item, and any indicia are all associated with the web page so that the customer may be directed to the right location to complete a sale or rental transaction. At step 205 the vendor prints out any written material (and or indicia or stickers) to be used with the item at its sale location. At step 206 the vendor secures the item at the desired location and locks the item. The vendor makes sure that any necessary instructions are affixed to the item or are otherwise available to a potential consumer.

Sale Transaction

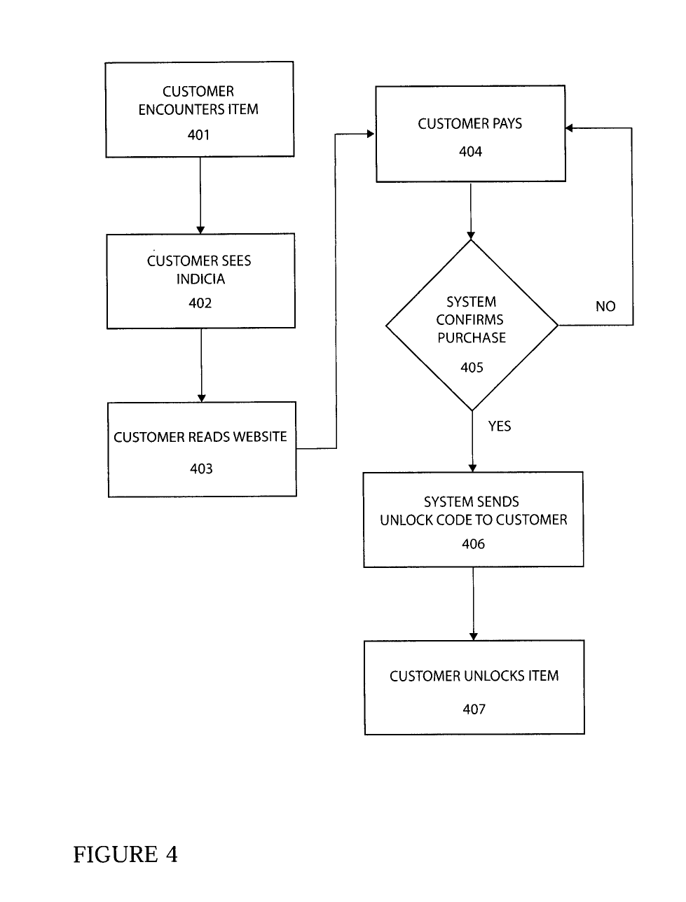

FIG. 4 is a flow diagram illustrating the operation of one embodiment of the system during a transaction. In this example, a sale is described, but the system has equal application to rental transactions as well, as described below.

At step 401 the customer encounters the item. This may be by finding it at its locked location, via any online or offline advertising, or through any other means. At step 402 the customer finds the indicia that will allow the customer to access online information about the item for sale. This may be via a posted URL, a 2D bar code, QR code, bar code, text message code, phone number or any other suitable means. In one embodiment, the user may use a smartphone to scan a code and be taken directly to a website.

At step 403 the user reads the website to find information about the item, including price, status, features, or any other information that may be useful in helping to make a determination to make a purchase. Included on the website is information about the process, including informing the customer that they can take immediate possession by paying for the item and receiving the unlock code or combination. At step 404 the customer initiates the purchase at the website, via any suitable means such as credit card, PayPal, cash, text message payment, and the like. Alternatively the customer could be directed to a call center or some other manner of making a financial transaction. These and other forms of payment may be used in all embodiments, including special purpose credit or debit cards, such as, or similar to, transit passes, “Oyster” type cards, library cards, and the like.

At decision block 405 it is determined if the purchase has been confirmed and the funds approved. If not, the system returns to step 404. If so, the system proceeds to step 406 and the system sends the unlock code to the customer. At step 407 the customer unlocks the item and takes possession of the item. An electronically generated receipt is provided to the customer and the vendor's databases are updated appropriately.

Rental Embodiment

In one embodiment the system is used for rental instead of purchase. In one embodiment, the customer pays the rental amount plus a deposit and takes the locking mechanism during the rental period. After use, the renter is asked to change the combination after returning the rental equipment. The system must either supply the customer this new combination or the customer must submit the combination that they set the lock to. In one embodiment, the renter's deposit is not returned until verification of the item's return has been made. In one embodiment, this verification can occur when the next customer rents the equipment. At that point, the system knows that the item has been returned and can return the first customer's deposit. In this example, the first customer no longer will know the code of the lock, because the new customer will also be asked to reset it upon return.

The customer receives back their deposit either when the item is rented again or when the vendor can check that the item has been returned and is unharmed. For rentals with this system, the time of the return is difficult to verify. In one embodiment, a GPS tracer in the item that verifies that it is back at the stated location that the rental customer reports. In one embodiment, video surveillance at the location verifies that the item is returned; and a fine is levied against false claims that an item is returned and sporadic checks are made that item(s) are returned. In one embodiment the item includes an RFID chip and the system can scan the return location for the presence of the item. The fines can be taken out of the deposit for the rental merchandise.

In addition, without video surveillance, it is difficult to determine the difference between an item that is not returned or returned and then stolen before a new customer rents it or the owner verifies the return.

For this reason, this rental embodiment could use other theft prevention measures. Potentially, the threat of a GPS tracking system may be enough to prevent theft and/or non-return of rental merchandise. In the case of key-operated motorized vehicles or equipment, keys can be permanently fixed and only the combination lock would prevent the equipment form being taken.

An alternate iteration of this embodiment is lending, in which payment is voided and instead there is just a digital signature which constitutes agreement to the terms and conditions of the borrowing, potentially including liability for loss, damage or theft of the item.

Another embodiment is the locker embodiment and this embodiment of this system allows lockers to become vending machine. The combination of each lock is inputted into the locker database, 124, of the system, along with the description of the item. This information is then placed on the locker. When new items are placed in this locker, the same URL can be used and just the combination changed. This will allow the advertisement on the door of the locker to stay the same even if there are different items in the locker.

Another embodiment is the locker/rental embodiment and this embodiment of this system allows for rentals, although it is important that there is a way to see into the locker, because for the rental embodiment of the present system it is important that each new customer sees that that item has been returned. If the customer does not see if the item is returned, pays and then claims that the item was not in the locker, then it is not clear whether the previous customer lied about returning it or it was stolen by another party or if it was a false claim for a missing item.

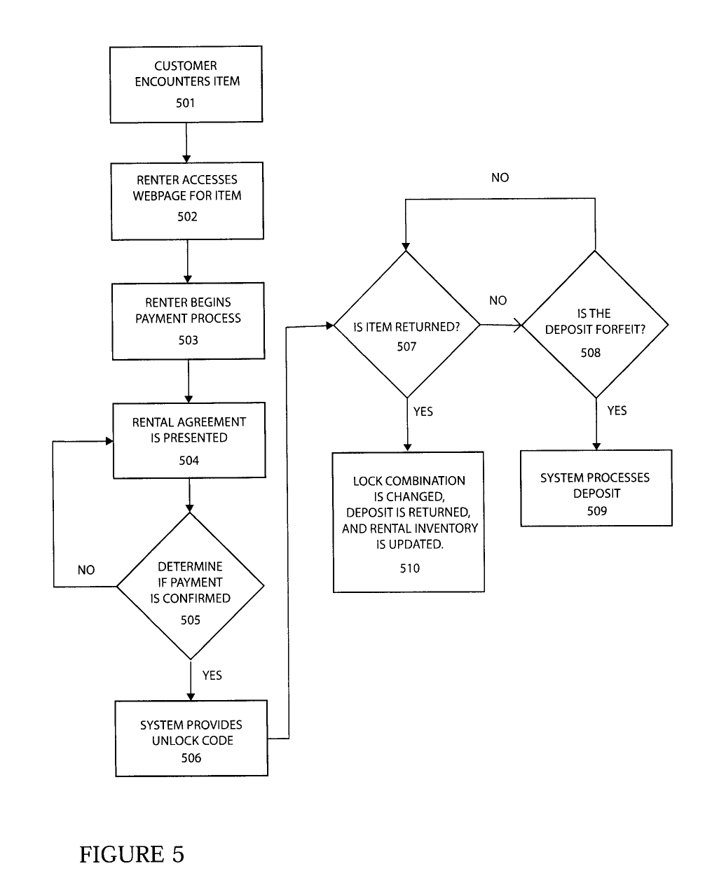

FIG. 5 is a flow diagram illustrating the operation of an embodiment of the system in rental mode. At step 501 the renter encounters the item for rent. At step 502 the renter accesses the web site that provides the description and payment fulfillment capability for the item to be rented. (Note that in alternate embodiments, the location of the item could have its own non-networked computing and payment system for handling rental and code provision).

At step 503 the renter elects to rent the item and begins the payment process. At step 504 the system presents the rental cost and a deposit amount that will be returned if the rented item is returned appropriately. At decision block 505 it is determined if the payment transaction is confirmed. If not, the system returns to step 504. If so, the system proceeds to step 506 and provides the unlock code to the renter.

At step 507 the system checks to see if the rental item has been returned appropriately. This step can take one or more of several approaches. In one embodiment, the rental item is considered to have been returned appropriately upon the next rental transaction of the item. The theory is that the next renter would not have rented the item if it was not present and in good condition. In another embodiment, this step involves the vendor periodically visiting the rental location and confirming the return and condition of the rented item. In another embodiment, the rented item may come from a locked bin with an integrated RFID reader that can confirm when the item has been returned.

If the item has not been returned at step 507, the system proceeds to step 508 to determine if the deposit is forfeit. This may be due to exceeding the time allowed for use, exceeding some agreed upon time limit in the rental agreement, by physical inspection of the rental location and finding a damaged or missing rental item, upon the complaint of the next potential renter of damage to the item, and the like. If the deposit is forfeit at step 508, the system processes deposit at step 509. If not, the system returns to step 507.

If the item has been appropriately returned at step 507, the system proceeds to step 510 where the lock combination is changed, the deposit returned, and the rental inventory updated. The changing of the combination may be accomplished by any of the methods described herein.

Helmet Sales and Rental

Bike rentals are popular, particularly in tourist destinations. A concern for some is the desire (or requirement) for the use of a helmet when riding. However, many tourists do not pack helmets when they travel, so there is a need for helmets for rent or purchase wherever bikes are rented or purchased. In using an unattended system, such as contemplated here, the system provides a way to vend helmets as well.

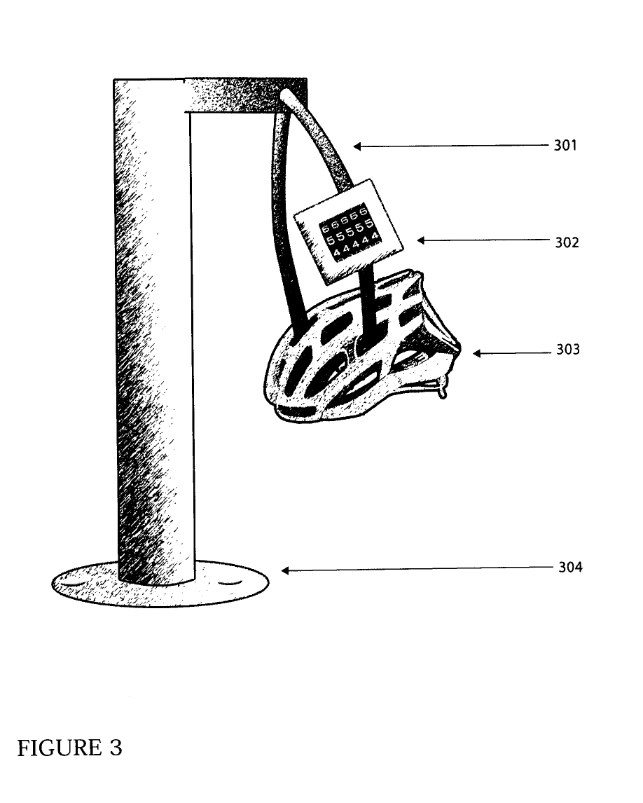

FIG. 3 is an example of a helmet vending embodiment. A mounting device, such as pole 304, is used to securely attach a helmet for vending or rental. The helmet 303 is attached to the pole 304 via cable 301. Cable 301 is secured via lock 302. Lock 302 may be a mechanical combination lock, a digital lock (i.e. with an electronic keypad for entering and changing the unlock code), or any combination thereof. When a customer desires to obtain a helmet, the user will access the system (via printed information on or near the helmet, and proceed as outlined above.

If the helmet is for rental, the user will return the helmet when done and re-secure it to the post 304. At this point the user will be instructed to reset the combination of the lock 302. In one embodiment, the system instructs the user to cause the lock to enter a resetting state such that the lock combination will be reset, without the customer knowing the new combination. In one embodiment, the lock will reset to a known next combination that is available to the vendor, and the system can be updated accordingly. In another embodiment, the customer is asked to enter a new combination and to report it to the system so that the system can update its records.

In one embodiment, the helmet includes an RFID chip or some other identification that may be electronically detected. For example, and RFID reader could be incorporated in or near the pole 304 that is capable of scanning the RFID of the helmet when the helmet is secured in place. In this manner, the system can have more certainty that the item has been returned. It should be noted that the RFID system is not limited to the rental of helmets, but has equal applicability to all other embodiments of the system, whether sale, rental, lending, or other.

Still another embodiment is the reduced input from vendor embodiment. A list of many combinations for one item type and location can be given to the vendor or created by the vendor and inputted at once. The system will then release each subsequent combination in the list one after the other upon each payment. The vendor changes the combination to the subsequent one without having to update the combination online.

With this embodiment, customers should check to see that the item has been restocked. If each customer sees whether the lock has been restocked with a new item before purchase, the correct combination will always be supplied. The system in this embodiment only works if the purchase is made at the location of the item, because there is nothing else to prevent multiple customers to buy the item before it has been restocked. If this was to happen, a customer could have the incorrect combination. For this embodiment, the software should not allow two customers to buy items in rapid succession, where it was not feasible that the item could have been restocked.

Kiosk Embodiment

In another embodiment, the system is implemented in a kiosk environment. In this embodiment, a kiosk or vending machine is provided with multiple locations for storing items in a secure manner. There may be a single locking system for the entire kiosk or there may be one locking mechanism per storage location. Instead of inserting cash into the system, the customer can pay online and receive an unlock code as noted above. The customer then uses the code to open the storage location and access the item.

For purchased items, the vendor will have instant inventory update and will be able to efficiently schedule resupply of the kiosk. For rented items, the system can operate as described above.

The system may operate in any number of ways. In one embodiment, information and data to allow the user to access a web page is provided at the kiosk. In another embodiment, the kiosk may include its own internet access, via a tablet computer, on premises smartphone, or an internet accessible terminal. In another embodiment, the kiosk may have one or more telephone handsets that allow a customer to reach a call center and conduct the transaction accordingly.

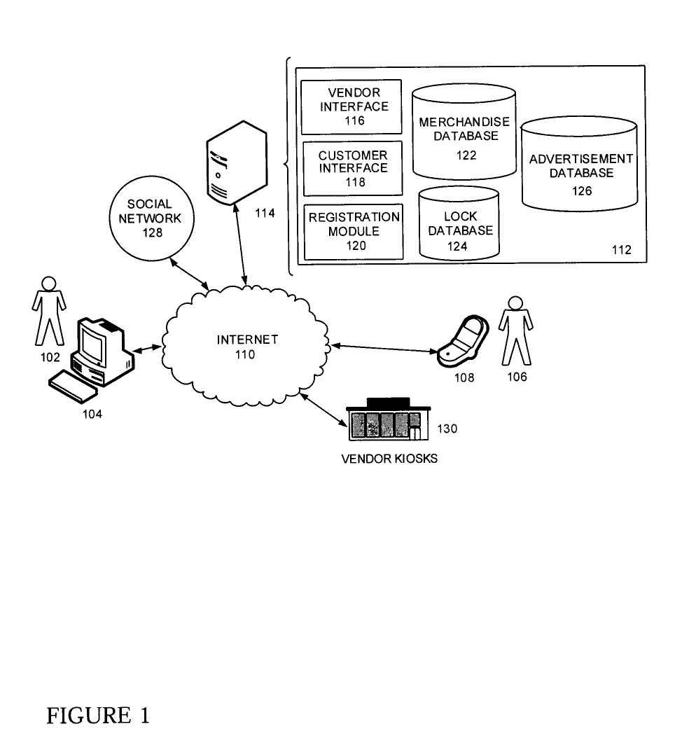

In another embodiment, the kiosk does not have internet access, but is a closed system where all the functions happen within the kiosk itself. (For example, the kiosk 130 may be directly coupled to a processing system such as server 114 of FIG. 1). The kiosk may have a local processing system that is offline but includes the software and database necessary to conduct the transactions. The customer chooses which item he or she is buying either by typing a code into the kiosk that is displayed on the merchandise or locker, by selecting the item from a list or by other means. The customer then pays for the item, either by the means above or the like. Then the customer receives the combination. It can be shown on the screen, printed, text messaged or emailed. The central benefit of this embodiment is that the kiosk does not need internet access to function and that customers do not need internet access or the ability to pay by mobile phone.

FIG. 1 describes one example embodiment of the system and includes a kiosk environment. In this embodiment of the system as illustrated in FIG. 1, a vendor 102 locks the merchandise in a private or public place with a combination lock Any combination lock can be used. The lock can be digital or analog and have letters, numerals or other figures.

The vendor 102 enters facts about the item and configures the item's advertising page on a computing device 104 connected over the Internet 110 or any computer network, such as a LAN, long area network, or WAN, wide area network, to collection of interfaces and databases 112 and then a server 114. All aspects of the process are customizable and a reseller can reuse settings. A reseller can reuse settings for similar items added multiple times. Important fields can include name, price, location, description of lock or code, description of merchandise, lock combination(s) or code(s), the deposit amount and rate for rentals, whether or not the vendor wishes the merchandise to be listed on a map of items, whether or not the vendor wishes the merchandise to be added to additional listing services, and pictures and/or audio and/or video describing the merchandise. The information entered by the vendor 102 through its computing device 104 to a server 114 hosting the vendor interface 116 and a registration module 120. The merchandise registration information is stored on the merchandise database 122 together with a lock code selected from the lock database 124.

The system generates a web page for locked merchandise with price and “check out,” “add to cart,” “pay-to-unlock,” “pay to receive combination” or “send payment” buttons to buy item. The advertisement web page is stored on the advertisement database 126 and can be display on the customer interface 118.

A server merchandise database 122 keeps all the information entered about the item for sale. The system posts information about the item on a map and posts the information simultaneously on other sites such as a social network 128 as to notify potential customers that the item is for sale.

The system generates a printable form on the vendor's computing device 104 for the vendor to print and place as advertisement on or near the merchandise. Multiple formats are provided to the vendor simultaneously for printing. For this form, a Quick Response (QR) code, or other bar code, is also generated to correspond to the URL of the item and to send the potential customer to the correct URL for payment. In addition, this form can have information, such as a telephone number, for texting payment directly for the item or a number to call to receive the combination or code.

A customer 106 sees the merchandise with the ad on it and by means of his computing device 108 which is connected to the internet 110 enters the URL posted on the item via typing, speaking the URL into their smartphone, or by photographing/scanning the QR bar code, scanning a bar code, and the like.

The customer 106 could also find the item on the online map, where items are posted. Customer pays for the item via an online or mobile text payment system accessed by their computing device 108. Alternatively, the customer 106 can pay by credit card over the phone. The system is notified that payment has been made and the database entry for item on the merchandise database 124 is updated as sold.

The system then alters the web page entry on the advertisement database 126, for the item to state that it has been sold. Alternatively, the web page can be deleted or simply updated with a new description and combination needed to sell the item when it is restocked. The system supplies the corresponding combination and sends the combination in electronic form to the customer's computing device 108. Customer 106 receives the combination via text message, a document with the combination in it, a voice message, email, an encrypted html document online, or an unencrypted hidden online document and/or other forms of electronic communication.

The customer now owns the merchandise and can unlock and take it. The customer takes off the “for sale” label. The customer either takes the lock because it was part of the purchase, leaves the lock because it is affixed or leaves the lock, and when the vendor verifies that the lock is still there, customer gets a refund for the lock. Verification that the lock is still there can come from another vendor or customer using the same lock. The lock could also be returned by mail or at a drop-off location for a refund by the customer.

The reseller vendor 102 changes the combination of the lock, restocks the lock with new merchandise and updates system that the item is in stock. The same URL and signage can be re-used by the vendor 102 for the same type of item. Also the same lock can be used if the combination can be changed. The same URL can also be used even if it is a different item for sale. The vendor 102 can change the name or features of the item in the merchandise database 124 and as long as the same URL is being served up for the signage, it can be reused. This allows for the distribution of a large number of relatively inexpensive items to be dispensed.

In one embodiment the system uses a kiosk 130 as the location for locking one or more items. The kiosk may have internet capability that may be used by the customer, it may be independent of the internet yet have local processing such as server 114, or it may be such that all communication in the system is via the user's communication device (e.g. smartphone or computing device).

Embodiment of Computer Execution Environment (Hardware)

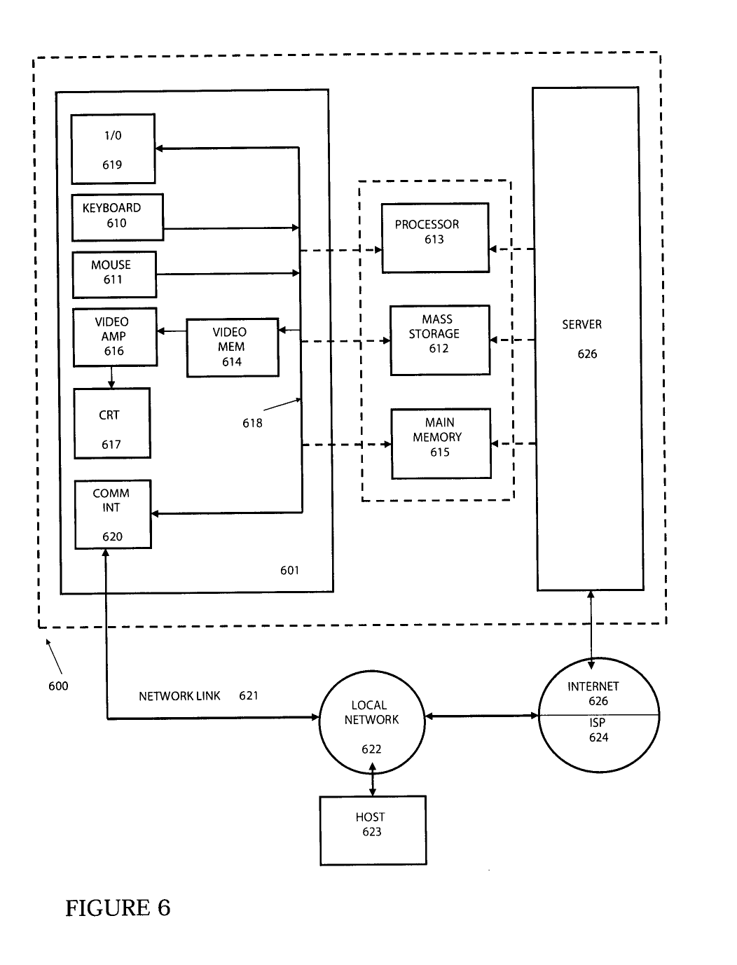

An embodiment of the system can be implemented as computer software in the form of computer readable program code executed in a general purpose computing environment such as environment 600 illustrated in FIG. 6, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 610 and mouse 611 are coupled to a system bus 618. The keyboard and mouse are for introducing user input to the computer system and communicating that user input to central processing unit (CPU 613. Other suitable input devices may be used in addition to, or in place of, the mouse 611 and keyboard 610. I/O (input/output) unit 619 coupled to bi-directional system bus 618 represents such I/O elements as a printer, A/V (audio/video) I/O, etc.

Computer 601 may be a laptop, desktop, tablet, smart-phone, or other processing device and may include a communication interface 620 coupled to bus 618. Communication interface 620 provides a two-way data communication coupling via a network link 621 to a local network 622. For example, if communication interface 620 is an integrated services digital network (ISDN) card or a modem, communication interface 620 provides a data communication connection to the corresponding type of telephone line, which comprises part of network link 621. If communication interface 620 is a local area network (LAN) card, communication interface 620 provides a data communication connection via network link 621 to a compatible LAN. Wireless links are also possible. In any such implementation, communication interface 620 sends and receives electrical, electromagnetic or optical signals which carry digital data streams representing various types of information.

Network link 621 typically provides data communication through one or more networks to other data devices. For example, network link 621 may provide a connection through local network 622 to local server computer 623 or to data equipment operated by ISP 624. ISP 624 in turn provides data communication services through the world wide packet data communication network now commonly referred to as the “Internet” 626 Local network 622 and Internet 626 both use electrical, electromagnetic or optical signals which carry digital data streams. The signals through the various networks and the signals on network link 621 and through communication interface 620, which carry the digital data to and from computer 600, are exemplary forms of carrier waves transporting the information.

Processor 613 may reside wholly on client computer 601 or wholly on server 626 or processor 613 may have its computational power distributed between computer 601 and server 626. Server 626 symbolically is represented in FIG. 6 as one unit, but server 626 can also be distributed between multiple “tiers”. In one embodiment, server 626 comprises a middle and back tier where application logic executes in the middle tier and persistent data is obtained in the back tier. In the case where processor 613 resides wholly on server 626, the results of the computations performed by processor 613 are transmitted to computer 601 via Internet 626, Internet Service Provider (ISP) 624, local network 622 and communication interface 620. In this way, computer 601 is able to display the results of the computation to a user in the form of output.

Computer 601 includes a video memory 614, main memory 615 and mass storage 612, all coupled to bi-directional system bus 618 along with keyboard 610, mouse 611 and processor 613.

As with processor 613, in various computing environments, main memory 615 and mass storage 612, can reside wholly on server 626 or computer 601, or they may be distributed between the two. Examples of systems where processor 613, main memory 615, and mass storage 612 are distributed between computer 601 and server 626 include thin-client computing architectures and other personal digital assistants, Internet ready cellular phones and other Internet computing devices, and in platform independent computing environments,

The mass storage 612 may include both fixed and removable media, such as magnetic, optical or magnetic optical storage systems or any other available mass storage technology. The mass storage may be implemented as a RAID array or any other suitable storage means. Bus 618 may contain, for example, thirty-two address lines for addressing video memory 614 or main memory 615. The system bus 618 also includes, for example, a 32-bit data bus for transferring data between and among the components, such as processor 613, main memory 615, video memory 614 and mass storage 612. Alternatively, multiplex data/address lines may be used instead of separate data and address lines.

In one embodiment of the invention, the processor 613 is a microprocessor such as manufactured by Intel, AMD, Sun, etc. However, any other suitable microprocessor or microcomputer may be utilized, including a cloud computing solution. Main memory 615 is comprised of dynamic random access memory (DRAM). Video memory 614 is a dual-ported video random access memory. One port of the video memory 614 is coupled to video amplifier 619. The video amplifier 619 is used to drive the cathode ray tube (CRT) raster monitor 617. Video amplifier 619 is well known in the art and may be implemented by any suitable apparatus. This circuitry converts pixel data stored in video memory 614 to a raster signal suitable for use by monitor 617. Monitor 617 is a type of monitor suitable for displaying graphic images.

Computer 601 can send messages and receive data, including program code, through the network(s), network link 621, and communication interface 620. In the Internet example, remote server computer 626 might transmit a requested code for an application program through Internet 626, ISP 624, local network 622 and communication interface 620. The received code maybe executed by processor 613 as it is received, and/or stored in mass storage 612, or other non-volatile storage for later execution. The storage may be local or cloud storage. In this manner, computer 600 may obtain application code in the form of a carrier wave. Alternatively, remote server computer 626 may execute applications using processor 613, and utilize mass storage 612, and/or video memory 615. The results of the execution at server 626 are then transmitted through Internet 626, ISP 624, local network 622 and communication interface 620. In this example, computer 601 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

While the communication network has been described in connection with certain examples, is the system is not limited to the disclosed embodiments, but on the contrary, includes various modifications and equivalent arrangements. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or multiple computers. The apparatus can include special purpose logic circuitry, e.g., a FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. Examples include use of scanners of all sorts and use of microphones. In addition, in one embodiment, a user can scan a QR code and thus input data into the system. The QR code referred to in the previous sentence and throughout this application, can also be any bar code, matrix code, or 2D code. If the user chooses to scan a QR code, the system will use predetermined information and settings to create a reminder for the user. If the QR code is a typical QR code, i.e., not created via the smartphone application described above, then all the information contained in the QR code such as links, addresses, etc. . . . will be stored as text in a note reminder. The settings for the name of the reminder, the time and date at which point in time the reminder will be triggered will be filled in automatically by the system described above. Under settings the user can set and save parameters for reminders and then, after scanning the QR code, determines whether the reminder is time based or location based or both. After setting the reminder the user can change any setting at any time. If the QR code that was scanned by the user was created through the website version of the aforementioned system, then the settings for the reminders will all be generated from the QR code and the user can only edit the reminder once said reminder has been created. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the invention. For example, the actions recited in the description can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other implementations are also within the scope of the invention.

What is claimed is:

1. A method of implementing a financial transaction for an item comprising:
securing an item at a location with a locking mechanism wherein the locking mechanism may be opened using a code;
in a processing system;
associating a payment processing system with the item;
accessing the payment processing system by a user and providing payment for the item;
providing the user with the code upon confirmation of the payment.

2. The method of claim 1 further including the user unlocking the locking mechanism using the code and taking possession of the item.

3. The method of claim 1 wherein the financial transaction is a purchase.

4. The method of claim 1 wherein the locking mechanism is a combination lock.

5. The method of claim 1 wherein the locking mechanism is a digital lock.

6. The method of claim 1 wherein the item includes indicia for providing a path to the payment processing system.

7. The method of claim 6 wherein the payment processing system is a web page.

8. The method of claim 6 wherein the payment processing system is a call center.

9. The method of claim 6 wherein the indicia comprises a bar code.

10. The method of claim 6 wherein the indicia comprise a QR code.

11. The method of claim 6 wherein the indicia is a URL.

12. The method of claim 1 wherein the item is disposed in a box secured by the locking mechanism.

13. The method of claim 1 wherein the financial transaction is a rental transaction.

14. The method of claim 13 wherein the user pays a deposit in addition to a rental price for renting the item.

15. The method of claim 14 wherein the deposit is not returned until the next time the item is rented.
